(19) United States
(12) Patent Application Publication
(10) Pub. No.: US 2012/0250169 A1
(43) Pub. Date: Oct. 4, 2012

(54) OSCILLATOR, VIBRATION ACTUATOR, LENS BARREL, CAMERA, BONDED PRODUCT AND BONDING METHOD

(75) Inventors: Kunihiro KUWANO, Kawasaki-shi (JP); Satoshi KARIYA, Yokohama-shi (JP)

(73) Assignee: NIKON CORPORATION, Tokyo (JP)

(21) Appl. No.: 13/433,249

(22) Filed: Mar. 28, 2012

(30) Foreign Application Priority Data
Mar. 29, 2011 (JP) 2011-072712

(51) Int. Cl. H02N 2/04; B32B 15/00; B23K 31/02; G02B 7/09; B32B 37/10

(52) U.S. Cl. 359/824; 310/323.16; 156/285; 228/101; 428/457

(57) ABSTRACT

An oscillator includes an electromechanical energy conversion element and an elastic body. The elastic body is bonded with the electromechanical energy conversion element by metallic bonding and is configured to be driven by deformation of the electromechanical energy conversion element.

This application is based on and claims the benefit of priority from Japanese Patent Application No. 2011-072712 filed on 29 Mar. 2011, the contents of which are incorporated herein by reference.

### BACKGROUND OF THE INVENTION

1. Field of the Invention

The present invention relates to an oscillator, a vibration actuator, a lens barrel, a camera and a bonded product, as well as a bonding method of the oscillator and bonded product.

2. Related Art

A vibration actuator causes an electromechanic energy conversion element to deform by a driving signal, so that an elastic body bonded with the electromechanic energy conversion element is driven. Accordingly, the vibration actuator causes a relative movement member in pressure contact with the elastic body to move. For bonding the electromechanic energy conversion element with the elastic body, an adhesive and an adhesive layer are generally used (see Japanese Unexamined Patent Application Publication No. H5-261647).

### SUMMARY OF THE INVENTION

According to one aspect of the present invention, an oscillator includes an electromechanical energy conversion element and an elastic body. The elastic body is bonded with the electromechanical energy conversion element by metallic bonding and is configured to be driven by deformation of the electromechanical energy conversion element.

According to another aspect of the present invention, a method for producing an oscillator includes bonding an electromechanical energy conversion element and an elastic body by metallic bonding to produce the oscillator. The elastic body is configured to be driven by deformation of the electromechanical energy conversion element.

According to further aspect of the present invention, a bonded product includes a first member and a second member. The second member is bonded with the first member by vacuum bonding at room temperature. The vacuum bonding includes surface activation. Either one of the first member and the second member is metal-plated.

According to the other aspect of the present invention, a method for bonding a first member with a second member includes: applying metal plating to either one of the first member and the second member; and bonding the first member with the second member by vacuum bonding at room temperature. The vacuum bonding includes surface activation.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front view of a vibration actuator according to an exemplary embodiment;

FIG. 2 is a conceptual diagram of a camera using the vibration actuator of FIG. 1; and

FIG. 3 is a flowchart describing steps of a method for bonding a driving body and a piezoelectric element by surface activated bonding (SAB) at room temperature.

### DETAILED DESCRIPTION OF THE INVENTION

An oscillator, a vibration actuator provided with the oscillator, a lens barrel provided with the vibration actuator, a camera provided with the lens barrel, and a method for bonding the oscillator as an embodiment of the present invention will be described with reference to the drawings.

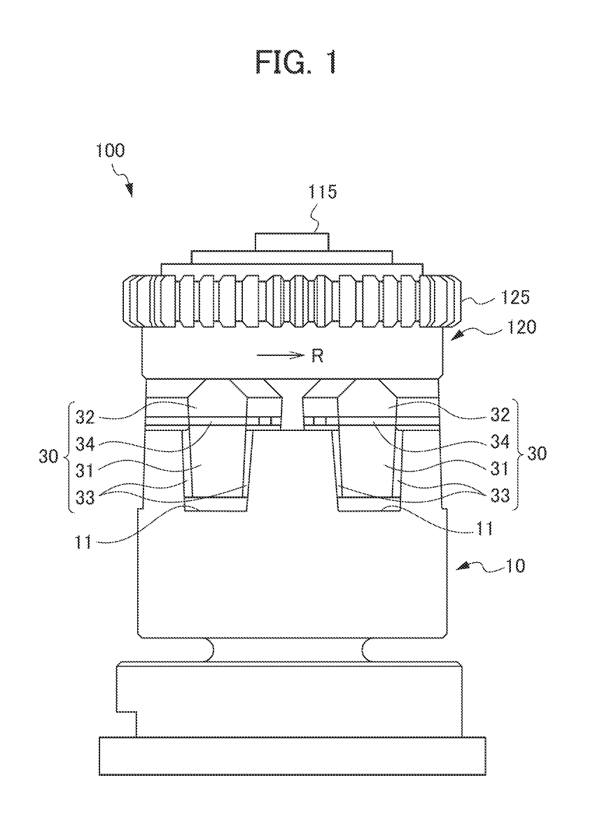

FIG. 1 is a front view of a vibration actuator 100.

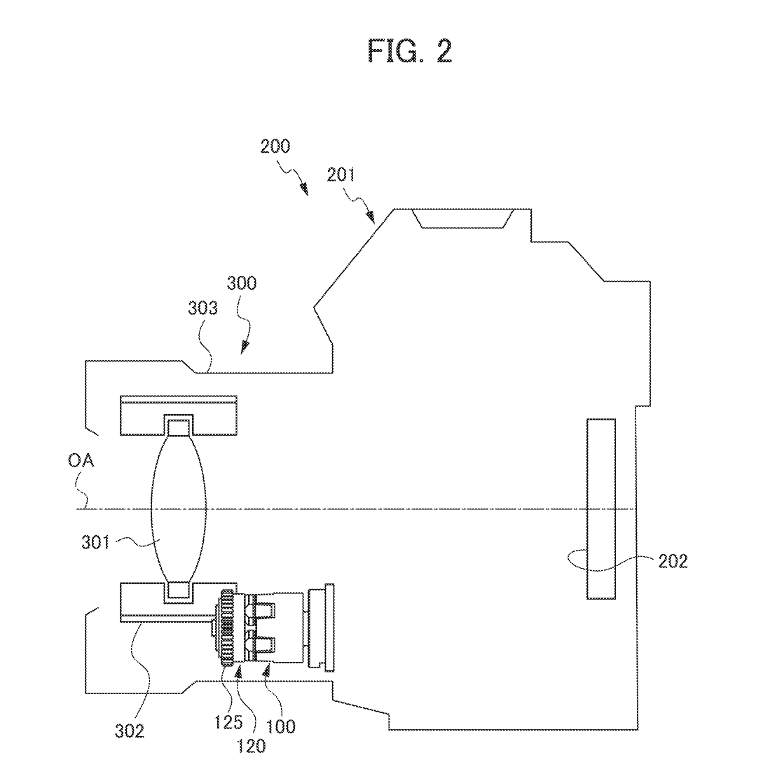

FIG. 2 is a conceptual diagram of a lens barrel 300 provided with the vibration actuator 100 and a camera 200 to which the lens barrel 300 is attached.

As shown in FIG. 1, the vibration actuator 100 according to the present embodiment includes a base member 10 and a rotor 120 placed on the base member 10.

The base member 10 is formed of a metallic material such as stainless steel in a hollow cylindrical shape, through which a supporting shaft 15 is centrally inserted and fixed. At an end portion of the base member 10 facing the rotor 120, six supporting concavities 11 that accommodate driving mechanisms 30 (described later) are provided in a peripheral direction, for example.

The rotor 120 is rotatably supported by the supporting shaft 15.

On an outer peripheral surface of the rotor 120, a gear 125 is formed to output a rotational force. The rotor 120 is supported by the driving mechanisms 30.

The number of the driving mechanisms 30 is six, which are supported respectively by the six supporting concavities 11 provided in the peripheral direction. Each of the driving mechanisms 30 includes: a lifter 31 that lifts the rotor 120; a slider 32 that causes the rotor 120 to move in a rotational direction; a lift driving unit 33 disposed between the lifter 31 and the base member 10; and a slide driving unit 34 disposed between the lifter 31 and the slider 32.

A lifter 31 is accommodated in each of the six supporting concavities 11 at the base member 10. An upper face of the lifter 31 projects upward from an upper face of the base member 10 by a predetermined amount.

The lift driving unit 33 and the slide driving unit 34 are each provided with two piezoelectric elements arranged in parallel with each other. Each piezoelectric element is a rectangular plate formed of piezoelectric zirconate titanate (PZT), for example, and provides a piezoelectric effect. An oscillation mode resulting from the piezoelectric effect is a thickness-shear mode. The lift driving unit 33 is disposed between an outer face of the lifter 31 and an inner wall surface of the supporting concavity 11. The lift driving unit 33 is bonded with the outer face of the lifter 31 by vacuum bonding at room temperature.

The slider 32 is provided on an upper face of the lifter 31 via the slide driving unit 34. An upper face of the slider 32 is a flat driving surface 32A with which the rotor 120 is held in pressure contact.

A driving voltage is applied respectively to the lift driving unit 33 and the slide driving unit 34 by a driving circuit controlled by a control device (not illustrated). The driving voltage causes the lift driving unit 33 to oscillate so as to drive the lifter 31 to vertically move. Accordingly, the slide driving unit 34 oscillates to drive the slider 32 to move in a peripheral direction R.

Among the six driving mechanisms 30, a group of alternate driving mechanisms 30 is in the same phase and operates in a different phase from another group of alternate driving mechanisms 30. As a result, the driving mechanisms 30 of the same group alternately support the rotor 120 in the peripheral direction R and drive the rotor 120 to move relative to the base member 10, thereby continuously driving the rotor 120 to rotationally move in the peripheral direction R.

FIG. 2 is a conceptual diagram of the camera 200 to which the lens barrel 300 provided with the vibration actuator 100 is attached.

The camera 200 includes a camera body 201 having an imaging device 202, and the lens barrel 300. The lens barrel 300 is an interchangeable lens that is mountable to and detachable from the camera body 201. It should be noted that although the lens barrel 300 is an interchangeable lens in the present embodiment, the present invention is not limited thereto. It may alternatively be possible that the lens barrel 300 is formed integral with a camera body.

The lens barrel 300 includes: a focusing lens 301; a cam barrel 302; the vibration actuator 100; and a housing 303 that surrounds these components; and the like. The vibration actuator 100 is disposed in an annular gap between the cam barrel 302 and the housing 303. The vibration actuator 100, in which the gear 125 of the rotor 120 is configured to engage with a gear formed on an outer periphery of the cam barrel 302, drives the cam barrel 302 to rotationally move. In this manner, the vibration actuator 100 drives the focusing lens 301 while the camera 200 is in a focusing operation.

The cam barrel 302 is provided inside the housing 303 to be movable in a direction parallel to an optical axis OA according to a rotational operation performed by the vibration actuator 100. The focusing lens 301 is supported by the cam barrel 302. The focusing lens 301 moves in a direction of the optical axis OA, following movement of the cam barrel 302 driven by the vibration actuator 100. In this manner, focusing is adjusted. Although not illustrated, the lens barrel 300 includes a plurality of lens groups in addition to the focusing lens 301.

The focusing lens 301 is driven by the vibration actuator 100 according to a position of an object, focusing is adjusted, and an image of the object is formed on an imaging surface of the imaging device 202. The imaging device 202 converts the image of the object thus formed into an electric signal, which is A/D converted to obtain image data.

Next, a method for bonding the lifter 31 and the lift driving unit 33 according to the present embodiment will be described. In the present embodiment, the lifter 31 and the lift driving unit 33 are bonded by vacuum bonding at room temperature. As the vacuum bonding at room temperature, surface activated bonding at room temperature (SAB) is employed.

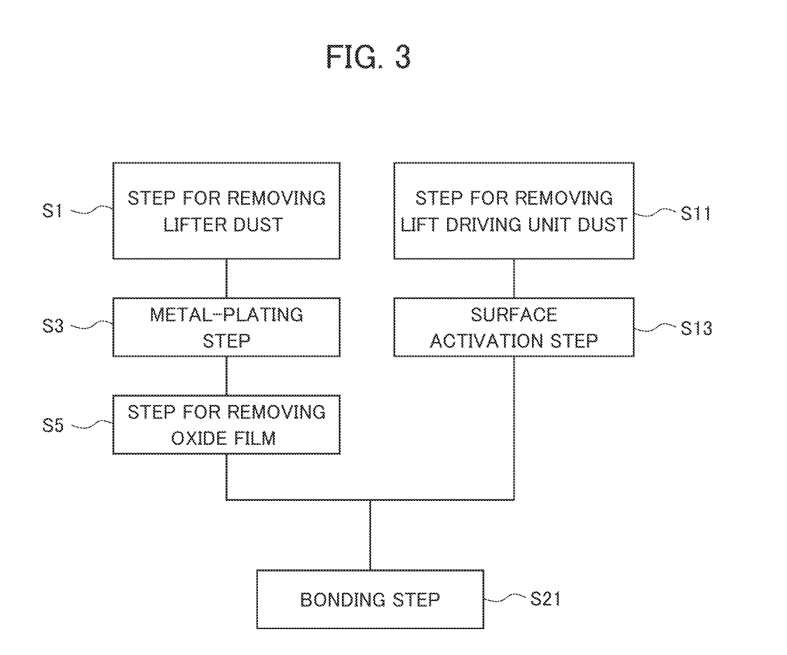

FIG. 3 is a flow chart describing the method for bonding the lifter 31 and the lift driving unit 33.

First, the lifter 31 is washed to remove dust (dust removing step, S1). Thereafter, the lifter 31 is soaked in a metal plating tank to apply metal plating to a bonding surface 31a of the lifter 31 to which the lift driving unit 33 is bonded (metal-plating step, S3). It may be possible to use metal plating such as copper, tin, gold, silver, and nickel plating or the like. Experimental results reveal that copper plating is suitable in terms of bonding properties. It may be preferable but not necessary that the thickness of metal plating is in a range of 0.1 μm to 10 μm.

It may be preferable but not necessary that a metal-plated surface and a surface of the lift driving unit 33 are flat so that these surfaces are better bonded.

It may be preferable but not necessary that with respect to a surface roughness condition, Ra (an average value of roughness) and Rz (a maximum value of roughness) are both no greater than 1 μm. It may be preferable but not necessary that with respect to a geometric tolerance condition, the flatness is no greater than 0.5 μm over an entirety of the bonding surface.

It may be preferable but not necessary that the metal-plated surface is not oxidized. Therefore, the metal-plated surface is subjected to a process for chemically removing an oxide film from a bonding surface (oxide film removing step, S5).

It may be preferable but not necessary that the oxide film removing step is performed immediately prior to bonding.

The lift driving unit 33 is also washed to remove dust (dust removing step, S11). Thereafter, a surface activation process is performed to sputter a bonding surface 33a of the lift driving unit 33, so that the oxide film on the bonding surface 33a is removed (surface activation step, S13).

In this case, it may be preferable but not necessary that with respect to a surface roughness condition, Ra and Rz of the surface of the lift driving unit 33 are no greater than 1 μm so that bonding is better performed.

It may be preferable but not necessary that with respect to a geometric tolerance condition, the flatness is no greater than 0.5 μm over an entirety of the bonding surface.

Next, the metal-plated part of the lifter 31 is bonded with the surface-activated part of the lift driving unit 33 (bonding step, S21). Here, the surface of the metal plating is a non-oxidized and activated surface. As a result, surface atoms of the metal plating of the lifter 31 are bonded with surface atoms of the activated surface of the lift driving unit 33. Accordingly, the lifter 31 is bonded with the lift driving unit 33 at room temperature.

Bonding of the lifter 31 and the lift driving unit 33 has been described above. Bonding of the lifter 31 and the slide driving unit 34, as well as bonding of the slider 32 and the slide driving unit 34 are also performed by SAB. It may be that the lift driving unit 33 is bonded with the inner wall surface of the supporting concavity 11 by vacuum bonding at room temperature.

The present embodiment described above has the following advantageous effects.

(1) According to the present embodiment, there is no need to use an adhesive that inhibits transmission of oscillations between a piezoelectric body and an elastic body.

As a result, the oscillations of the piezoelectric body are transmitted to the elastic body without attenuation. Accordingly, it is possible to increase the efficiency of transmitting the oscillations from the piezoelectric body to the oscillator. In this case, the vibration actuator with an elastic body of high oscillation transmission efficiency can quickly perform starting and stopping operations.

A camera including the vibration actuator that can quickly perform starting and stopping operations can perform the focusing operation quickly, resulting in an increase in the user-friendliness associated with the camera.

(2) In the manufacturing step of the oscillator 30, it is possible to eliminate steps of: applying an adhesive; maintaining an adhesion state by a fixture; thermally curing the adhesive; removing the fixture; and the like, thereby increasing the productivity.

In addition, it is possible to eliminate control of an amount of applied adhesive (thickness of applied adhesive), a temperature of the adhesive, a curing temperature, curing time and the like of the adhesive, thereby facilitating manufacturing control.

(3) The lifter 31 is bonded with the lift driving unit 33 and the slide driving unit 34 at room temperature. The slider 32 is bonded with the slide driving unit 34 at room temperature. Accordingly, the lift driving unit 33 and the slide driving unit 34, which are piezoelectric elements, will not be thermally deformed. Since the joining will not be damaged, it is possible to increase the efficiency of transmitting oscillation.

### Modifications

The present invention is not limited to the abovementioned embodiment and may also be embodied as follows.

(1) It may alternatively be possible that the metal evaporation is applied to the lifter 31 and the slider 32 instead of the metal plating.

(2) It may alternatively be possible that sputtering or etching is applied to the surfaces of the lifter 31 and the slider 32 instead of metal plating.

(3) It may alternatively be possible that the metal plating is applied to the lift driving unit 33 and the slide driving unit 34 instead of the lifter 31 and the slider 32, and the surface activation is applied to the lifter 31 and the slider 32.

(4) It may alternatively be possible to apply metal bonding between the lifter 31 and the lift driving unit 33, between the lifter 31 and the slide driving unit 34, and between the slider 32 and the slide driving unit 34 in the following manner: a) the surface activation is applied to both a first group of the lifter 31 and the slider 32 and a second group of the lift driving unit 33 and the slide driving unit 34 instead of applying the metal plating to one of the first and second groups; b) a metal foil (for example, a copper foil) is placed between the lifter 31 and the lift driving unit 33, between the lifter 31 and the slide driving unit 34, and between the slider 32 and the slide driving unit 34, respectively; c) metal foils and these components are bonded by vacuum bonding at room temperature.

(5) In the bonding step (S21) of bonding the lifter 31 with the lift driving unit 33, the lifter 31 with the slide driving unit 34, and the slider 32 with the slide driving unit 34, it may alternatively be possible that these components are held in pressure contact with each other. Since irregularities are flattened even if the bonding surface has a relatively higher roughness, it is possible to increase the bonding properties.

(6) It may alternatively be possible to adopt vacuum bonding at room temperature using metal covalent bonding instead of metal bonding including surface activation.

The above described embodiments and modifications may be used in suitable combinations, though detailed descriptions are not given herein. The present invention is in no way limited by the exemplary embodiments described above.

Obviously, numerous modifications and variations of the present invention are possible in light of the above teachings. It is therefore to be understood that within the scope of the appended claims, the invention may be practiced otherwise than as specifically described herein.

What is claimed is:

1. An oscillator comprising:
an electromechanical energy conversion element; and
an elastic body bonded with the electromechanical energy conversion element by metallic bonding and configured to be driven by deformation of the electromechanical energy conversion element.

2. The oscillator according to claim 1, wherein the metallic bonding comprises vacuum bonding.

3. The oscillator according to claim 2, wherein the vacuum bonding comprises vacuum bonding at room temperature.

4. The oscillator according to claim 3, wherein the vacuum bonding at room temperature comprises surface activation.

5. The oscillator according to claim 1, wherein a surface of either one of the electromechanical energy conversion element and the elastic body is metal-plated, the surface being bonded with another of the electromechanical energy conversion element and the elastic body by the metallic bonding.

6. The oscillator according to claim 1, wherein
a metal foil is interposed between the electromechanical energy conversion element and the elastic body,
the electromechanical energy conversion element is bonded with the metal foil by the metallic bonding, and
the elastic body is bonded with the metal foil by the metallic bonding.

7. The oscillator according to claim 1, wherein the electromechanical energy conversion element is bonded with the elastic body by the metallic bonding in a state in which the electromechanical energy conversion element is held in pressure contact with the elastic body.

8. A vibration actuator comprising:
the oscillator according to claim 1.

9. A lens barrel comprising:
the vibration actuator according to claim 8.

10. A camera comprising:
the lens barrel according to claim 9.

11. A method for producing an oscillator, the method comprising:
bonding an electromechanical energy conversion element and an elastic body by metallic bonding to produce the oscillator, the elastic body being configured to be driven by deformation of the electromechanical energy conversion element.

12. The method according to claim 11, wherein the metallic bonding comprises vacuum bonding.

13. The method according to claim 12, wherein the vacuum bonding comprises vacuum bonding at room temperature.

14. The method according to claim 13, wherein the vacuum bonding at room temperature comprises surface activation.

15. The method according to claim 11, further comprising:
applying metal plating to a surface of either one of the electromechanical energy conversion element and the elastic body prior to the metallic bonding; and
bonding the surface with another of the electromechanical energy conversion element and the elastic body by the metallic bonding.

16. The method according to claim 11, further comprising:
placing a metal foil between the electromechanical energy conversion element and the elastic body prior to the metallic bonding;
bonding the electromechanical energy conversion element with the metal foil by the metallic bonding; and
bonding the elastic body with the metal foil by the metallic bonding.

17. The method according to claim 11, wherein the bonding by the metallic bonding is performed in a state in which the electromechanical energy conversion element is held in pressure contact with the elastic body.

18. A bonded product comprising:
a first member; and
a second member bonded with the first member by vacuum bonding at room temperature, the vacuum bonding including surface activation, either one of the first member and the second member being metal-plated.

19. The bonded product according to claim 18, wherein the vacuum bonding at room temperature is performed in a state in which the first member is held in pressure contact with the second member.

20. A method for bonding a first member with a second member, the method comprising:
applying metal plating to either one of the first member and the second member; and
bonding the first member with the second member by vacuum bonding at room temperature, the vacuum bonding including surface activation.

21. The method according to claim 20, wherein the bonding by the vacuum bonding at room temperature is performed in a state in which the first member is held in pressure contact with the second member.
